(19) United States
(12) Patent Application Publication
(10) Pub. No.: US 2003/0171967 A1
(43) Pub. Date: Sep. 11, 2003

(54) System and method of deploying self-service travel terminals

(75) Inventors: John C. Goodwin III, Suwanee, GA (US); Michael E. Halpern, Collingswood, NJ (US)

Correspondence Address: PAUL W. MARTIN, LAW DEPARTMENT, WHQ-5E, 1700 S. PATTERSON BLVD., DAYTON, OH, 45479-0001, US

(73) Assignee: NCR Corporation

(21) Appl. No.: 10/093,157

(22) Filed: Mar. 7, 2002

(51) Int. Cl. G06F 17/60

(52) U.S. Cl. 705/8

(57) ABSTRACT

A system and method of deploying self-service travel terminals which makes more effectively use of the self-service travel terminals. The system includes a computer for collecting travel information from the self-service travel terminals and from assisted-service travel terminals, for analyzing the travel information to determine optimal numbers and locations of the self-service travel terminals, and for generating a report containing optimal numbers and locations of the self-service travel terminals.

### BACKGROUND OF THE INVENTION

The present invention relates to self-service kiosks and more specifically to a system and method of deploying self-service travel terminals.

Kiosks provide a publicly accessible computing platform for displaying World Wide Web (web) pages and other web-delivered content from web sites. Kiosks may be located within a retailer's transaction establishment or elsewhere, such as in shopping malls. Kiosks may be easily networked to web sites using the TCP/IP protocol. Web pages from web sites may be displayed using known and available web software, such as Microsoft® Internet Explorer software.

Service companies deploy kiosks in order to improve the quality of their services and to provide customers with more service options. For example, transportation companies may deploy kiosks to reduce passenger waiting time in check-in lines.

Kiosk owners wish to make optimal use of kiosks. Therefore, it would be desirable to provide a system and method of deploying self-service travel terminals.

### SUMMARY OF THE INVENTION

In accordance with the teachings of the present invention, system and method of deploying self-service travel terminals is provided.

The system includes a computer for collecting travel information from the self-service travel terminals and from assisted-service travel terminals, for analyzing the travel information to determine optimal numbers and locations of the self-service travel terminals, and for generating a report containing optimal numbers and locations of the self-service travel terminals.

It is accordingly an object of the present invention to provide system and method of deploying self-service travel terminals.

It is another object of the present invention to make optimal use of deploying self-service terminals.

It is another object of the present invention to determine through historical testing the optimal number and location of deploying self-service terminals.

It is another object of the present invention to determine through historical testing the optimal number and location of deploying self-service travel terminals.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a transportation system; and

FIG. 2 is a flow diagram illustrating the method of the present invention.

### DETAILED DESCRIPTION OF THE PREFERRED EMBODIMENT

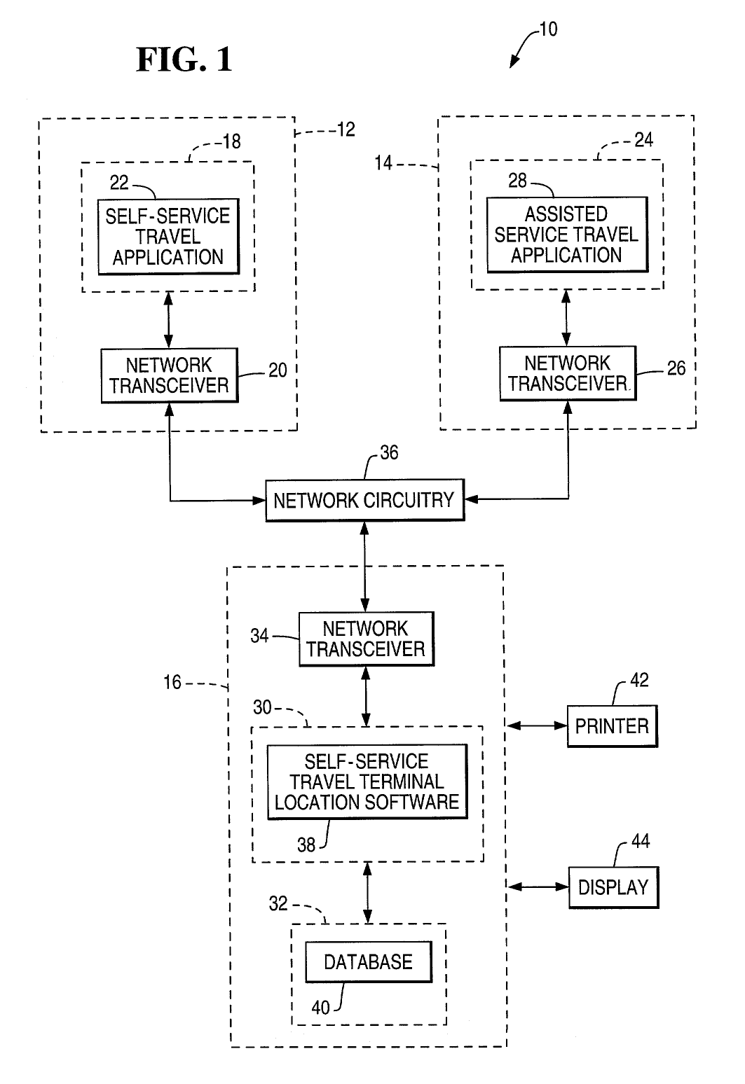

Turning now to FIG. 1, system 10 includes self-service travel terminal 12, assisted-service travel terminals 14, and server 16.

Self-service travel terminal 12 is preferably a kiosk located in a travel building, such as an airport or train station. Self-service travel terminal 12 is preferably mounted on wheels to make relocation easy, but the present invention also envisions other means for moving self-service travel terminal 12, such as dollies. Self-service travel terminal 12 may include an NCR 7401 computer.

Self-service travel terminal 12 includes processor 18 and network transceiver 20. Self-service travel terminal 12 additionally includes peripherals for completing a self-service request.

Processor 18 executes self-service travel self-service travel application 22. Self-service travel self-service travel application 22 processes travel-related requests from passengers. Self-service travel self-service travel application 22 may be a web (short for “World Wide Web” or “WWW”) application. A passenger may use self-service travel self-service travel application 22 to complete the check-in process, issue a boarding pass, change travel routes, or get scheduling information. Self-service travel self-service travel application 22 records passenger identification information, retrieves itinerary information from database 40 through server 16, displays instructions for completing check-in, records any payments due, dispenses any change due, prints boarding passes and tickets, and prints receipts. In addition, self-service travel application 22 records and stores travel history information in database 40. For example, self-service travel application 22 stores check-in times in database 40 during passenger check-in.

Self-service travel application 22 communicates with server 16 over a network connection, such as one that uses the TCP/IP protocol. Network transceiver 20 preferably includes a wireless transceiver to make moving self-service travel terminals 12 easier, but may include a wired network transceiver if wired connections are readily available.

Assisted-service travel terminals 14 includes processor 24 and network transceiver 26. Assisted-service travel terminals 14 execute assisted-service travel application 28, which also processes travel-related requests, except that a travel employee controls assisted-service travel application 28 to process the requests for the passengers. Assisted-service travel application 28 may be a web application. Assisted-service travel application 28 also records and stores travel history information in database 40. For example, assisted-service travel application 28 store check-in times in database 40 during passenger check-in.

Assisted-service travel terminals 14 communicates with server 16 over a network connection, such as one that uses the TCP/IP protocol. Network transceiver 26 may include a wired transceiver, since assisted-service travel terminals 14 are normally mounted in permanent locations.

Server 16 includes processor 30, storage medium 32, and network transceiver 34. Server 16 may be a web server. Processor 30 executes self-service travel terminal location software 38 which reads travel history data from database 40 to determine optimal numbers and locations for self-service travel terminals 12. Self-service travel terminal location software 38 generates reports containing the optimal number and locations and either prints the reports on printer 42 or displays them on display 44. Travel employees may then move self-service travel terminals 12 to these optimal locations.

Database 40 contains a list of possible departure locations, as well as information such as check-in time data, departure time data, arrival data, destination location data, and anticipated numbers of passengers. Database 40 contains data on individual travelers. Database 40 stores averages and trend information. Database 40 contains data on special events, such as sporting events, conventions, cruises, and associated destinations and departure and arrival times. Finally, database 40 may also store information about levels of customer travel experience.

For example, self-service travel terminal location software 38 may identify passenger loads at various locations and locate self-service travel terminals 12 at locations where passenger loads are the highest.

As another example, self-service travel terminal location software 38 may identify passenger check-in times at various locations and locate self-service travel terminals 12 at locations where the highest number of last-minute passenger check-ins occur.

As another example, self-service travel terminal location software 38 may identify flights whose late arrivals caused travelers to miss their next flights, and the number of travelers affected. Self-service travel terminal location software 38 may locate self-service travel terminals 12 near the arrival gate of the late flights.

As another example, self-service travel terminal location software 38 may identify flight cancellations and locate self-service travel terminals 12 at the gates of the canceled flights.

As another example, self-service travel terminal location software 38 may identify cruise arrival points and locate self-service travel terminals 12 at the arrival points.

Finally, self-service travel terminal location software 38 may identify numbers of high volume/short term travelers and times of day, and locate self-service travel terminals 12 at the arrival points where high volume short trip travelers arrive.

Server 16 communicates with self-service travel terminals 12 and assisted-service travel terminals 14 over a network connection. Network transceiver 34 may include a wired transceiver.

Network circuitry 36 connects server 16, self-service travel terminals 12, and assisted-service travel terminals 14. Network circuitry 36 may include a hub or switch, or combinations of hubs or switches or other commercially available network equipment to facilitate wired network operation or a combination of wired and wireless network operation.

Storage medium 32 stores database 40.

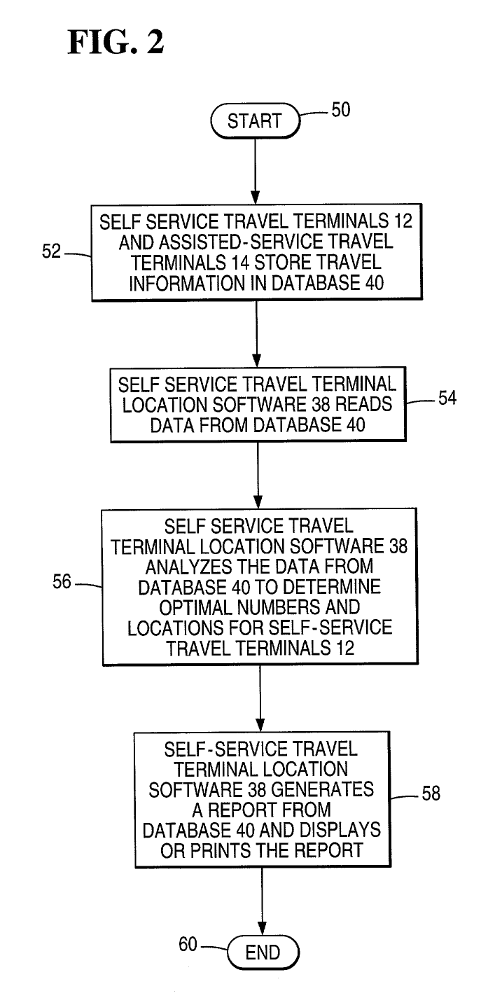

Turning now to FIG. 2, operation of system 10 is illustrated in detail beginning with START 50.

In step 52, self service travel terminals 12 and assisted-service travel terminals 14 store travel information in database 40.

In step 54, self-service travel terminal location software 38 reads data from database 40.

In step 56, self-service travel terminal location software 38 analyzes the data from database 40 to determine optimal numbers and locations for self-service travel terminals 12.

In step 58, self-service travel terminal location software 38 generates a report from database 40 and displays or prints the report. Travel management positions self-service travel terminals 12 based upon the results.

Knowing this information, travel management may improve customer service and more effectively use self-service travel terminals 12.

Operation ends at step 60.

Although the present invention has been described with particular reference to certain preferred embodiments thereof, variations and modifications of the present invention can be effected within the spirit and scope of the following claims.

We claim:

1. A method of deploying self-service travel terminals comprising the steps of:
(a) collecting travel information;
(b) analyzing the travel information to determine optimal numbers and locations of the self-service travel terminals; and
(c) generating a report containing optimal numbers and locations of the self-service travel terminals.

2. The method as recited in claim 1, further comprising the step of:
(d) communicating with the self-service travel terminals in the optimal locations over a wirelessly network connection.

3. The method as recited in claim 1, further comprising the step of:
(d) communicating with the self-service travel terminals in the optimal locations over a wired network connection.

4. A method of deploying self-service travel terminals comprising the steps of:
(a) collecting travel information by the self-service terminals and by assisted-service travel terminals;
(b) storing the travel information;
(c) analyzing the travel information to determine optimal numbers and locations of the self-service travel terminals; and
(d) generating a report containing optimal numbers and locations of the self-service travel terminals.

5. The method as recited in claim 4, further comprising the step of:
(e) communicating with the self-service travel terminals in the optimal locations over a wirelessly network connection.

6. The method as recited in claim 4, further comprising the step of:
(e) communicating with the self-service travel terminals in the optimal locations over a wired network connection.

7. A system of deploying self-service travel terminals comprising:
a computer for collecting travel information from the self-service travel terminals and from assisted-service travel terminals, for analyzing the travel information to determine optimal numbers and locations of the self-service travel terminals, and for generating a report containing optimal numbers and locations of the self-service travel terminals.

8. The system as recited in claim 7, further comprising:
a network transceiver for communicating with the self-service travel terminals in the optimal locations over a wirelessly network connection.

9. The system as recited in claim 7, further comprising:
a network transceiver for communicating with the self-service travel terminals in the optimal locations over a wired network connection.

10. A system of deploying self-service travel terminals comprising:
assisted-service travel terminals for collecting travel information;
a server coupled to the assisted-service travel terminals for analyzing the travel information to determine optimal numbers and locations of the self-service travel terminals, and for generating a report containing optimal numbers and locations of the self-service travel terminals; and
a network transceiver for communicating with the self-service travel terminals in the optimal locations over a wirelessly network connection.
